(19) United States
(12) Patent Application Publication
(10) Pub. No.: US 2018/0357604 A1
(43) Pub. Date: Dec. 13, 2018

(54) IoT-Driven Architecture of a Production Line Scheduling System

(71) Applicant: SAP SE, Walldorf (DE)

(72) Inventors: Wen-Syan Li, Shanghai (CN); Jing Gu, Shanghai (CN); Mingjie Dong, Shanghai (CN)

(21) Appl. No.: 15/620,681

(22) Filed: Jun. 12, 2017

(51) Int. Cl. G06Q 10/08; G06Q 10/06; G06Q 50/04; G06Q 10/10; H04Q 9/00

(52) U.S. Cl. CPC G06Q 10/0875; G06Q 10/06316; H04Q 9/00; G06Q 10/0838; G06Q 10/1097; G06Q 50/04

(57) ABSTRACT

Systems and methods are provided for tracking parts to be used in a production line. First and second digital outputs that represent, respectively, a first physical property of a first part and a second physical property of a second part, are received by one or more data processors. The first part has a first expected delivery date, and the second part has a second expected delivery date. The first and second physical properties are independently selected from the group consisting of humidity, temperature, and shock. The first digital output is compared to a first predetermined value representing damage to the first part. After a determination that first part is damaged and will not be available on the first expected delivery date, an alert is generated. The one or more data processors output the alert to at least one of a display screen and a computer-readable medium.

### TECHNICAL FIELD

The technology described herein relates generally to internet-of-things (IoT) technology and an IoT-driven architecture.

### BACKGROUND

Products are becoming increasingly more complex, with thousands of parts sourced from locations around the world. Companies that manufacture these products have the difficult task of processing a large amount of supply chain data and using it to guide product manufacture. For example, supply chain data is often scattered across multiple computer inventory systems and may not necessarily be available to the scheduler of the manufacturing production line. Furthermore, the available data may not necessarily be granular enough to be useful. Additionally, production line task scheduling can be complex.

### SUMMARY

Systems and methods are provided for tracking parts to be used in a production line. A first digital output based on first IoT sensor data associated with a first part is received by one or more data processors. The first digital output represents a first physical property of the first part, where the first part has a first expected delivery date. A second digital output based on second IoT sensor data associated with a second part is received by one or more data processors. The second digital output represents a second physical property of the second part, where the second part has a second expected delivery date. The first and second physical properties are independently selected from the group consisting of humidity, temperature, and shock. The first digital output is compared by one or more data processors to a first predetermined value representing damage to the first part. The second digital output is compared by one or more data processors to a second predetermined value representing damage to the second part. The one or more data processors determine that first part is damaged and will not be available on the first expected delivery date based on the comparison of the first digital output to the first predetermined value. The one or more data processors determine that the second part is not damaged and will be available on the second expected delivery date based on the comparison of the second digital output to the second predetermined value. An alert is generated by the one or more data processors that the first part will not arrive on the first expected delivery date based on the determination that the first part is damaged. The one or more data processors output the alert to at least one of a display screen and a computer-readable medium.

As another example, a computer-implemented system for tracking parts to be used in a production line includes: a first IoT sensor associated with a first part and configured to generate first IoT sensor data representing a first physical property of the first part, the first part having a first expected delivery date; a second IoT sensor associated with a second part and configured to generate second IoT sensor data representing a second physical property of the second part, the second part having a second expected delivery date; and at least one data processor having memory storing instructions, which execute the steps of a method. The first and second physical properties are independently selected from the group consisting of humidity, temperature, and shock. In the method, a first digital output based on first IoT sensor data is compared by the at least one data processor to a first predetermined value representing damage to the first part. A second digital output based on second IoT sensor data is compared by the at least one data processor to a second predetermined value representing damage to the second part. The at least one data processor determines that the first part is damaged and will not be available on the first expected delivery date based on the comparison of the first digital output to the first predetermined value. The at least one data processor determines that the second part is not damaged and will be available on the second expected delivery date based on the comparison of the second digital output to the second predetermined value. An alert is generated by the at least one data processor that the first part will not arrive on the first expected delivery date based on the determination that the first part is damaged. The at least one data processor outputs the alert to at least one of a display screen and a computer-readable medium.

As yet another example, systems and methods are provided for scheduling tasks in the manufacturing of a product. A set of possible sequences of tasks in manufacturing a product is generated by the one or more data processors. At least some of the tasks require a corresponding part, and at least some of the tasks have relationships with one another. For each sequence of the tasks in the set of possible sequences of the tasks, an allocation of parts required by the tasks in that sequence based on an expected arrival queue of parts required by the tasks of that sequence is generated by the one or more data processors. Each allocation is filtered by the one or more data processors to remove any tasks that have a corresponding part that is not in the arrival queue. A value for a workload metric based on the filtered allocation is generated by the one or more data processors. A sequence of the tasks in the set of possible sequences of the tasks is selected by the one or more data processors based on the value for the sequence. A probability of availability of each part required by the tasks of the sequence is generated by the one or more data processors and based on at least one of: (i) historical delivery data for that part and (ii) historical damage data for that part. A task score is generated by one or more data processors, for each task in the first sequence that requires a part based on the probability of availability of that part. A total score for the sequence of tasks based on the task scores of the tasks in the sequence is generated by the one or more data processors. A recommended scheduling of tasks based on the total score is generated by the one or more data processors. A recommended scheduling of tasks is output by the one or more data processors to at least one of a display screen and a computer-readable medium.

As a further example, a computer-implemented system for scheduling tasks in the manufacturing of a product includes at least one database that stores data comprising relationships between tasks and at least one of (i) historical delivery data for parts and (ii) historical damage data for parts, wherein the parts are needed by the tasks; and at least one data processor having memory storing instructions, which execute the steps of a method. In the method, a set of possible sequences of tasks in manufacturing a product is generated by the one or more data processors. At least some of the tasks require a corresponding part, and at least some of the tasks have relationships with one another. For each sequence of the tasks in the set of possible sequences of the tasks, an allocation of parts required by the tasks in that sequence based on an expected arrival queue of parts required by the tasks of that sequence is generated by the at least one data processor. Each allocation is filtered the at least one data processor to remove any tasks that have a corresponding part that is not in the arrival queue. A value for a workload metric based on the filtered allocation is generated by the at least one data processor. A sequence of the tasks in the set of possible sequences of the tasks is selected by one or more data processors based on the value for the sequence. A probability of availability of each part required by the tasks of the sequence is generated by the at least one data processor and based on at least one of: (i) historical delivery data for that part and (ii) historical damage data for that part. A task score is generated by the at least one data processor, for each task in the first sequence that requires a part based on the probability of availability of that part. A total score for the sequence of tasks based on the task scores of the tasks in the sequence is generated by the at least one data processor. A recommended scheduling of tasks based on the total score is generated by one the at least one data processor. A recommended scheduling of tasks is output by one the at least one data processor to at least one of a display screen and a computer-readable medium.

As another example, a non-transitory computer-readable medium storing one or more programs configured to be executed by one or more data processors, the programs comprising instructions to execute a method for scheduling tasks in the manufacturing of a product. A set of possible sequences of tasks in manufacturing a product is generated by the one or more data processors. At least some of the tasks require a corresponding part, and at least some of the tasks have relationships with one another. For each sequence of the tasks in the set of possible sequences of the tasks, an allocation of parts required by the tasks in that sequence based on an expected arrival queue of parts required by the tasks of that sequence is generated by the one or more data processors. Each allocation is filtered to remove any tasks that have a corresponding part that is not in the arrival queue. A value for a workload metric based on the filtered allocation is generated by the one or more data processors. A sequence of the tasks in the set of possible sequences of the tasks is selected by the one or more data processors based on the value for the sequence. A probability of availability of each part required by the tasks of the sequence is generated by the one or more data processors and based on at least one of: (i) historical delivery data for that part and (ii) historical damage data for that part. A task score is generated by the one or more data processors, for each task in the first sequence that requires a part based on the probability of availability of that part. A total score for the sequence of tasks based on the task scores of the tasks in the sequence is generated by the one or more data processors. A recommended scheduling of tasks based on the total score is generated by the one or more data processors. A recommended scheduling of tasks is output by the one or more data processors to at least one of a display screen and a computer-readable medium.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 schematically illustrates components of an exemplary system for the scheduling of tasks for a manufacturing production line.

FIG. 2 is a diagram that schematically depicts an exemplary supply chain scenario to which the present subject matter can be applied.

FIG. 3 is a process flow diagram illustrating a method for monitoring real-time status of a plurality of parts planned to be used in a manufacturing production line.

FIG. 4 is a process flow diagram for scheduling tasks for a manufacturing production line, the tasks having relationships with one another.

FIG. 5 is a diagram of an example time-windowed task topology that shows both series and parallel task execution.

FIG. 6 is an expansion of the topological diagram in FIG. 5.

FIG. 7 is an expansion of Tree 1 from the topological diagram in FIG. 6.

FIG. 8 is an expansion of Tree 1 from the topological diagram in FIG. 7.

FIG. 9 is an expansion of Tree 1 from the topological diagram in FIG. 8.

FIG. 10 is an expansion of Tree 1 from the topological diagram in FIG. 9.

FIG. 11 is a full expansion of Tree 2 from the topological diagram in FIG. 6.

FIG. 12 depicts an exemplary user interface that displays values for shock.

FIG. 13 depicts an exemplary user interface that displays values for temperature.

FIG. 14 depicts an exemplary user interface that displays a recommended task schedule.

FIG. 15 is a diagram illustrating a sample computing device architecture for implementing various aspects described herein.

Like reference symbols in the various drawings indicate like elements.

### DETAILED DESCRIPTION

The systems and methods presented herein provide efficient and cost-effective solutions for tracking parts and scheduling tasks in the manufacturing of a product. Efficiency and cost-savings can be achieved by leveraging IoT technology to track the real-time status of parts needed by the tasks, including whether parts are damaged or delayed. Any updates to the status of the parts can be automatically taken into account by the system, and the scheduling of tasks can be updated accordingly. Whereas previous attempts to create efficient scheduling were thwarted by the lack of visibility of the supply chain and the complexity of production line task scheduling, the present solution overcomes these obstacles by implementing IoT technology in creating, processing, and employing real-time and historical part data.

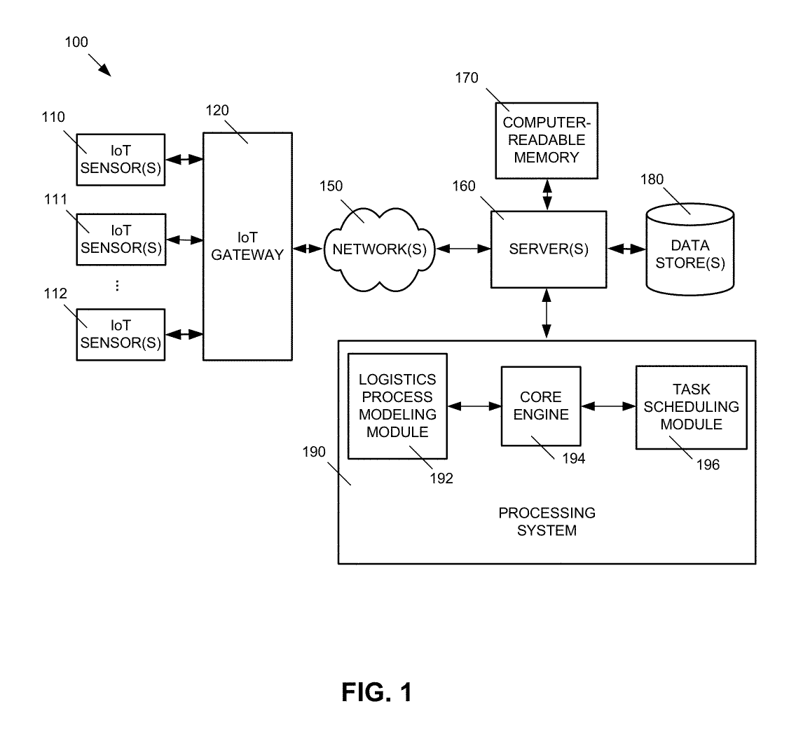

FIG. 1 schematically illustrates components of an exemplary system 100 for the scheduling of tasks for a manufacturing production line. In system 100, one or more IoT sensors 110, 111, and 112 are configured to generate sensor data that represents physical properties of parts. An IoT gateway 120 processes the data from the sensors 110, 111, and 112. The IoT gateway 120 can send data over one or more networks 150 to one or more servers 160. In an alternative configuration, the IoT sensors 110, 111, and 112 can send data directly over the one or more networks 150 to the one or more servers 160. The one or more servers 160 process the sensor data and transmit the processed sensor outputs received from the IoT gateway 120 or received directly from the IoT sensors 110, 111, and 112 to processing system 190. Processing system 190 includes logistics processing module 192, core engine 194, and the task scheduling module 196. The processed sensor outputs are used by the core engine 194. The logistics process modeling module 192 provides a model for the supply-chain process. The core engine 194 processes the model from the logistics process modeling module 192 and applies the model to the processed sensor outputs. The core engine 194 sends data to the task scheduling module 196 that runs on the processing system 190. The processing system 190 can access the one or more servers 160. The one or more servers 160 can access computer-readable memory 170 as well as one or more data stores 180.

IoT refers to the inter-networking of “smart” devices. The IoT sensors 110, 111, or 112 can use wireless and/or wired networking capability for transmitting data to the IoT gateway 120 or over the one or more networks 150. IoT sensors 110, 111, and 112 are configured to monitor one or more physical properties, such as temperature, humidity, and shock, in real-time, and to generate respective sensor data from the monitored physical properties. IoT sensors 110, 111, and 112 also or alternatively can include global positioning system (GPS) capability so as to generate an output representative of location. IoT sensors 110, 111, and 112 can be deployed in different locations throughout the supply chain, e.g., can accompany the parts that are being shipped. The sensor data from the monitored physical properties reflect the real-time status of the parts, including whether or not parts are damaged. The sensor data from the location of the parts indicates where they are in the shipment trajectory, and can be used to estimate the likelihood that the arrival of the parts will be delayed, as provided in greater detail herein.

In some instances, sensor data from a given one of IoT sensors 110, 111, and 112 can reflect the status of multiple parts. As one example, a sensor can be associated with (e.g., attached to) a shipping container holding the multiple parts. As another example, that sensor can be associated with (e.g., mounted in) a vehicle (such as a train, cargo ship, semi-trailer truck, or delivery vehicle) that transports the parts. In other instances, sensor data from one sensor can reflect the status of one part. As one example, a respective sensor can be incorporated into the packaging of each part individually.

The IoT gateway 120 can include any suitable computing device configured to aggregate sensor data, translate between sensor protocols, and process sensor data before sending the data over the one or more networks 150 to the one or more servers 160. An embedded database platform can be deployed on the IoT gateway 120 in order to support the data aggregation, translation, and processing. The IoT gateway 120 can include an edge computer or other suitable computing device. Edge computing can provide a performance boost because the processing of data is done close to the source of the data, and thus the volume of data to be moved over the network(s) 150 is decreased.

Alternatively, the raw data can be collected over the one or more networks 150, and appropriate data processing logic can be applied in the one or more servers 160. A remote data sync service on the one or more servers 160 can facilitate the syncing of the remote database at the source of the data with the centralized database on the one or more servers 160.

The logistics process modeling module 192 provides a model for the supply-chain process. The user of the processing system 190 can use logistics process modeling module 192 so as to define a model that describes business partners, such as “Supplier,” “Carrier,” and “Buyer,” and their respective roles in the supply-chain process. The model can also specify the sequence of events in the supply chain between the business partners, such as the ordering of parts and the sending of parts. The user can define event preferences, e.g., which events, such as events indicating damage or delay, should be received by the core engine 194.

Such events can be posted, e.g., provided to the core engine 194, in two ways: by the user of the system or by each business partner. The user of the system can get information from the business partners and post corresponding events. Alternatively, each business partner can send the events to and receive the events from the one or more servers 160 over the one or more networks 150. The event systems used by the business partners can be integrated on one platform.

The core engine 194 combines the real-time damage and delivery data for the parts with the event preferences to ascertain the actual event data, and can compare actual event data with the planned supply-chain event data. For example, given the potential for inaccuracies in the real-time damage data, the real-time damage data can be compared to the results of the manual quality check that is performed when the parts arrive at their final destination. The comparison can be used to get a probability that the parts will be damaged when an alert indicating damage is generated in the future.

The scheduling of tasks is performed by the task scheduling module 196, which resides on the processing system 190. The task scheduling module 196 can be configured to use a topological structure of the tasks, which comprises a set of relationships between the tasks. For example, a relationship between two tasks is that they may be executed in parallel or series. Tasks that are executed serially may also require a particular order of execution.

The task scheduling module 196 also uses the real-time part data that can come from either the one or more servers 160 or the IoT gateway 120. In the event that the delivery of a certain batch of parts is delayed or the parts are designated as damaged, the rescheduling of the tasks can be triggered accordingly. Thus any changes to the status of parts can trigger the task scheduling module 196 to generate a new schedule that incorporates the latest changes.

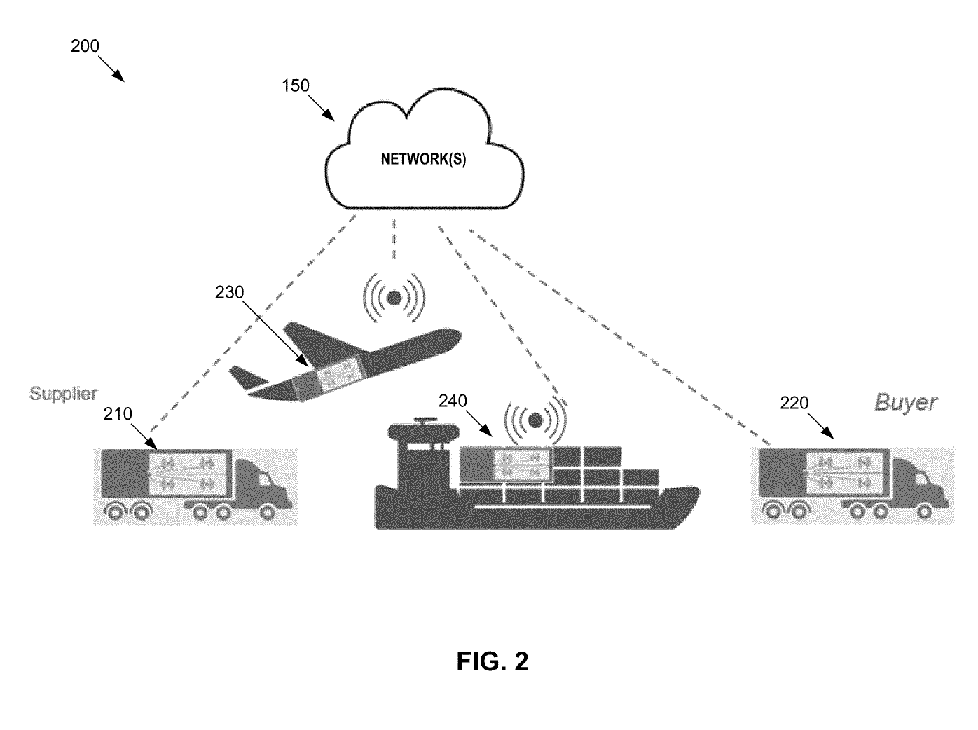

FIG. 2 is a diagram 200 that schematically depicts an exemplary supply chain scenario to which the present subject matter can be applied. The business partners, including the supplier 210 and the buyer 220, can send event information over the one or more networks 150 to the one or more servers 160. The one or more servers 160 can collect and process sensor data 230 and 240 that indicates the real-time status of the parts at various nodes in the transportation sequence.

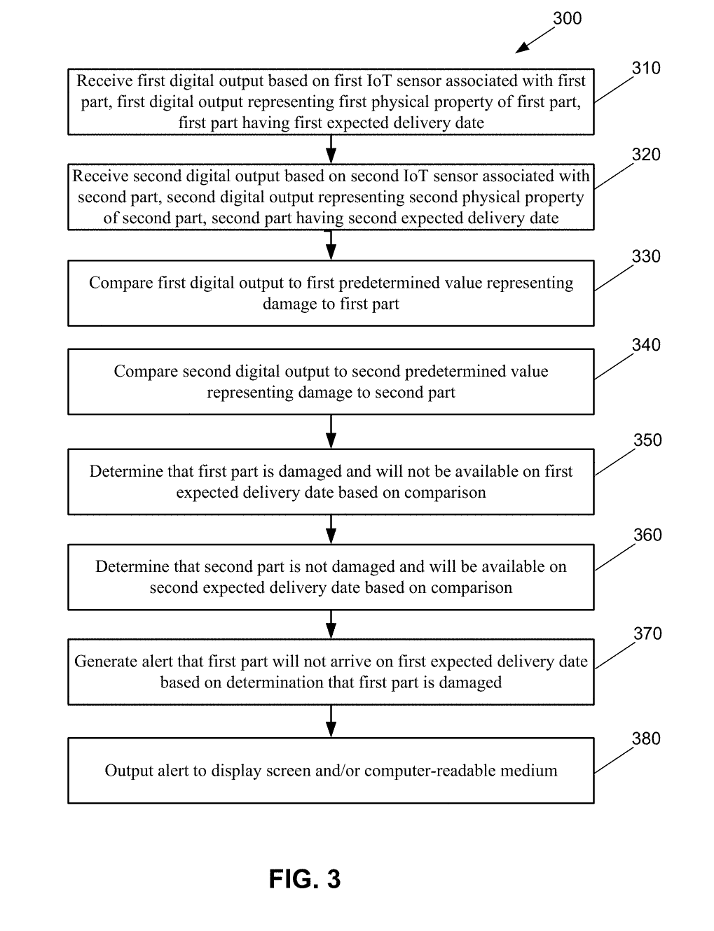

FIG. 3 is a process flow diagram 300 illustrating a method for monitoring real-time status of a plurality of parts planned to be used in a manufacturing production line. At operation 310, a first digital output based on first IoT sensor data associated with a first part is received by one or more data processors. As one example, the one or more servers 160 or the IoT gateway 120, in conjunction with the IoT sensors 110, 111, and 112, can perform operation 310. The first digital output represents a first physical property of the first part, where the first part has a first expected delivery date. At operation 320, a second digital output based on second IoT sensor data associated with a second part is received by one or more data processors. As one example, the one or more servers 160 or the IoT gateway 120, in conjunction with the IoT sensors 110, 111, and 112, can perform operation 320. The second digital output represents a second physical property of the second part, where the second part has a second expected delivery date. The first and second physical properties are independently selected from the group consisting of humidity, temperature, and shock. The first digital output is compared by one or more data processors to a first predetermined value representing damage to the first part at operation 330. As one example, the one or more servers 160 can perform operation 330. The second digital output is compared by one or more data processors to a second predetermined value representing damage to the second part at operation 340. As one example, the one or more servers 160 can perform operation 340. At operation 350, the one or more data processors determine that first part is damaged and will not be available on the first expected delivery date based on the comparison of the first digital output to the first predetermined value. As one example, the one or more servers 160 can perform operation 350. At operation 360, the one or more data processors determine that the second part is not damaged and will be available on the second expected delivery date based on the comparison of the second digital output to the second predetermined value. As one example, the one or more servers 160 can perform operation 360. An alert is generated at operation 370 by the one or more data processors that the first part will not arrive on the first expected delivery date based on the determination that the first part is damaged. As one example, the core engine 194 can perform operation 370. The one or more data processors output to at least one of a display screen and a computer-readable medium at operation 380. As one example, the core engine 194 can perform operation 380.

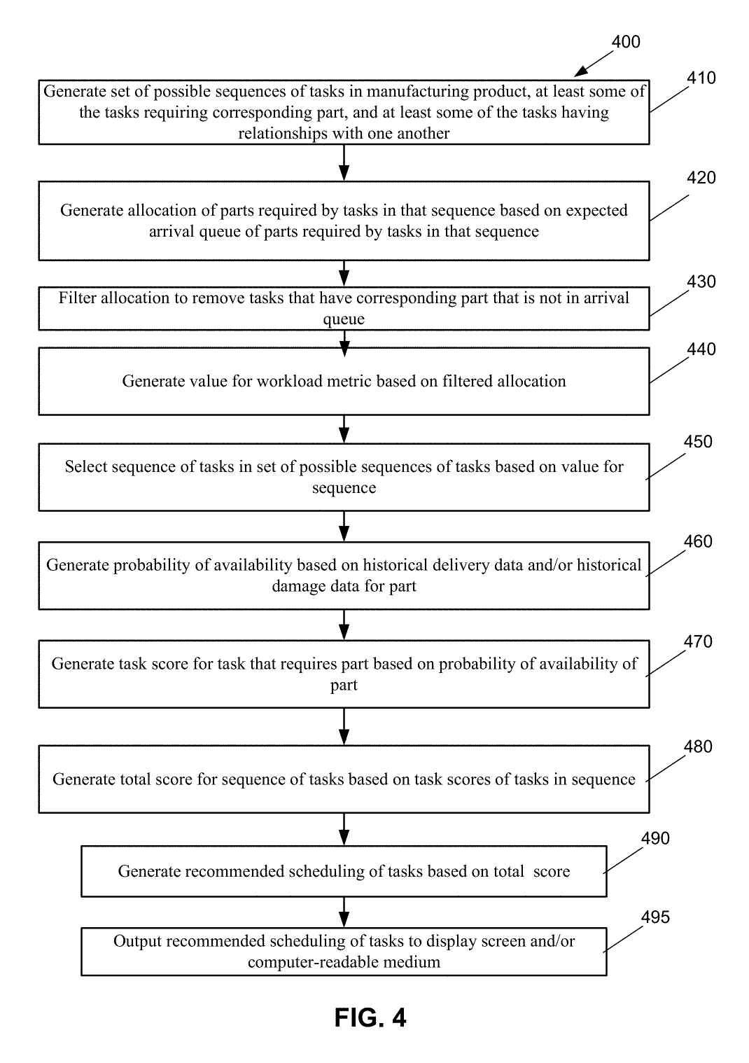

Additionally, process flow diagram 300 can be implemented independently of process flow diagram 400 described herein with reference to FIG. 4.

FIG. 4 is a process flow diagram 400 for scheduling tasks for a manufacturing production line, the tasks having relationships with one another. A set of possible sequences of tasks in manufacturing a product is generated by the one or more data processors at operation 410. As one example, the task scheduling module 196 can perform operation 410. At least some of the tasks require a corresponding part, and at least some of the tasks have relationships with one another. For each sequence of the tasks in the set of possible sequences of the tasks, an allocation of parts required by the tasks in that sequence based on an expected arrival queue of parts required by the tasks of that sequence is generated at operation 420 by the one or more data processors. As one example, the task scheduling module 196 can perform operation 420. Each allocation is filtered by the one or more data processors to remove any tasks that have a corresponding part that is not in the arrival queue at operation 430. As one example, the task scheduling module 196 can perform operation 430. At operation 440, a value for a workload metric based on the filtered allocation is generated by the one or more data processors. As one example, the task scheduling module 196 can perform operation 440. A sequence of the tasks in the set of possible sequences of the tasks is selected by the one or more data processors based on the value for the sequence at operation 450. As one example, the task scheduling module 196 can perform operation 450. A probability of availability of each part required by the tasks of the sequence is generated at operation 460 by the one or more data processors and based on at least one of: (i) historical delivery data for that part and (ii) historical damage data for that part. As one example, the task scheduling module 196 can perform operation 460. At operation 470, a task score is generated by one or more data processors, for each task in the first sequence that requires a part based on the probability of availability of that part. As one example, the task scheduling module 196 can perform operation 470. At operation 480, a total score for the sequence of tasks based on the task scores of the tasks in the sequence is generated by the one or more data processors. As one example, the task scheduling module 196 can perform operation 480. A recommended scheduling of tasks based on the total score is generated by the one or more data processors at operation 490. As one example, the task scheduling module 196 can perform operation 490. At operation 495, a recommended scheduling of tasks is output by the one or more data processors to at least one of a display screen and a computer-readable medium. As one example, the task scheduling module 196 can perform operation 495.

The steps shown in FIG. 4 can be carried out by the task scheduling module 196, and can be referred to as a “probability-based topological sorting.” At operation 410, the set of possible sequences of tasks is generated using a task topology, or a set of essential relationships between the tasks. The parts needed by the tasks might be expected to arrive within a specified time window. Thus, a time-windowed task topology that contains the essential relationships between the tasks for all the required parts will be available in that time window can be created. For example, the time window might be specified as three months in duration, and task A and task B can only be started after task C is finished. If not all the parts are available for task C in the next three months, then task C (and its follow-up tasks like A and B) will not be contained into the time-windowed task topology structure.

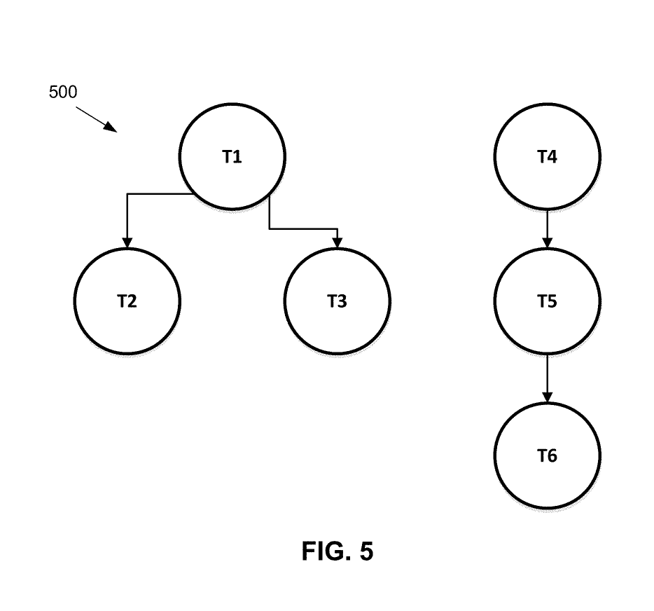

FIG. 5 is a diagram 500 of an example time-windowed task topology that shows both series and parallel task execution. This example task topology can reside on the data store 180 and can be used by the task scheduling module 196. Tᵢ denotes the task i. In this example, task 1 (T₁) must be completed before task 2 (T₂) and task 3 (T₃) can be started. After T₁ is completed, T₂ and T₃ can be implemented in parallel with one another. Task 4 (T₄) must be completed before task 5 (T₅) can be started. T₅ must be completed before task 6 (T₆) can be completed. T₄ can be completed in parallel with T₁, T₂, or T₃.

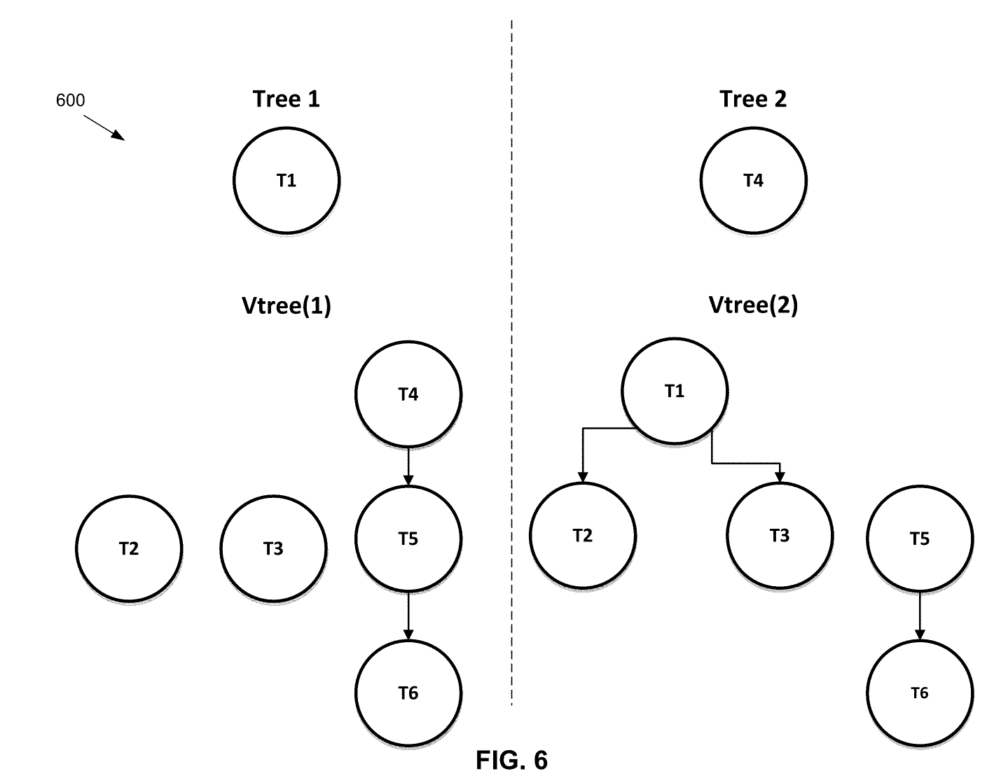

FIG. 6 is an expansion 600 of the topological diagram in FIG. 5. Each task is a node in the task topology. The set of task nodes can be represented by V={T₁, T₂, T₃ . . . Tₙ}. In this example, V={T₁, T₂, T₃, T₄, T₅, T₆}. the set of previous nodes of Task i in the topology can be represented by ̂Tᵢ={T₁, T₂, . . . , Tₖ}. For example, if Task C can only be started after Task A and Task B are completed, then ̂T_{C}={T_{A}, T_{B}}. The root nodes, which are nodes from V that have no previous nodes available in V, are identified. In the current example, the root notes are {T₁, T₄}. Each of these nodes forms the root of a tree, as depicted by FIG. 6. Tree 1 has T₁ as its root node. Tree 2 has T₄ as its root node. For each tree, V can be set to Vₜᵣₑₑ₍ᵢ₎, and the root node can be removed from the set of task nodes. For Tree 1, Vₜᵣₑₑ₍₁₎={T₂, T₃, T₄, T₅, T₆}. For Tree 2, Vₜᵣₑₑ₍₂₎={T₁, T₂, T₃, T₅, T₆}.

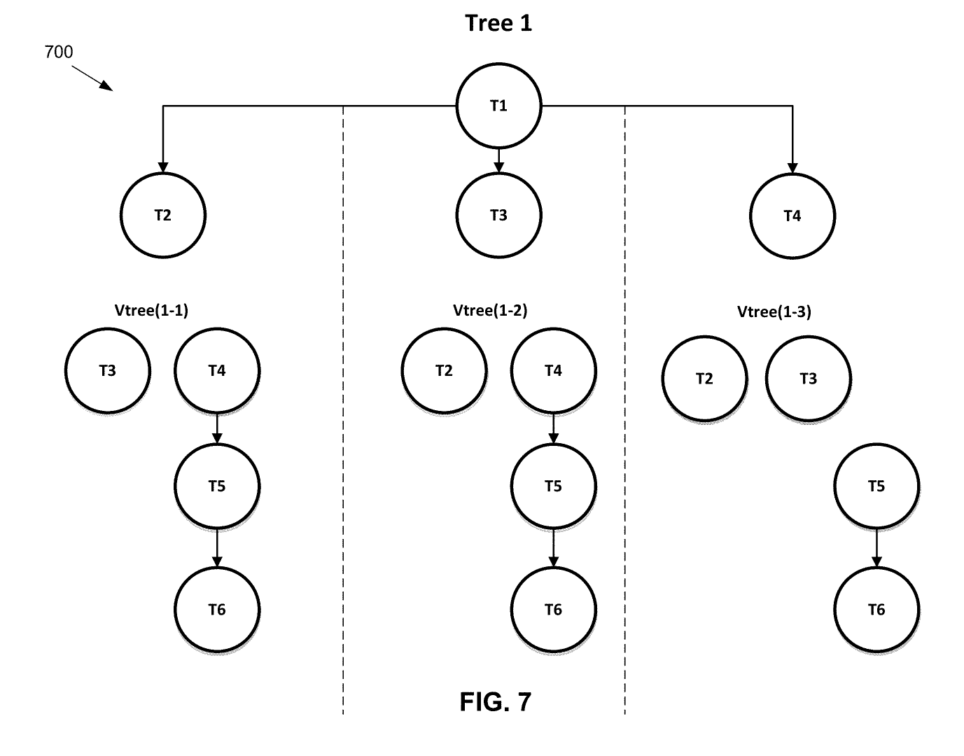

FIG. 7 is an expansion 700 of Tree 1 from the topological diagram in FIG. 6. For each Vₜᵣₑₑ₍ᵢ₎, the nodes that do not have previous nodes from Vₜᵣₑₑ₍ᵢ₎ are identified and appended to the root node as child nodes. For Tree 1, T₂, T₃, and T₄ have been appended to T₁ as child nodes. Each of the appended nodes becomes a new root node of a sub-tree. The Vₜᵣₑₑ₍ᵢ₎ will get smaller as nodes are removed and appended as children to the new root nodes of the sub-trees. This process can be repeated until Vₜᵣₑₑ₍ᵢ₎ is empty.

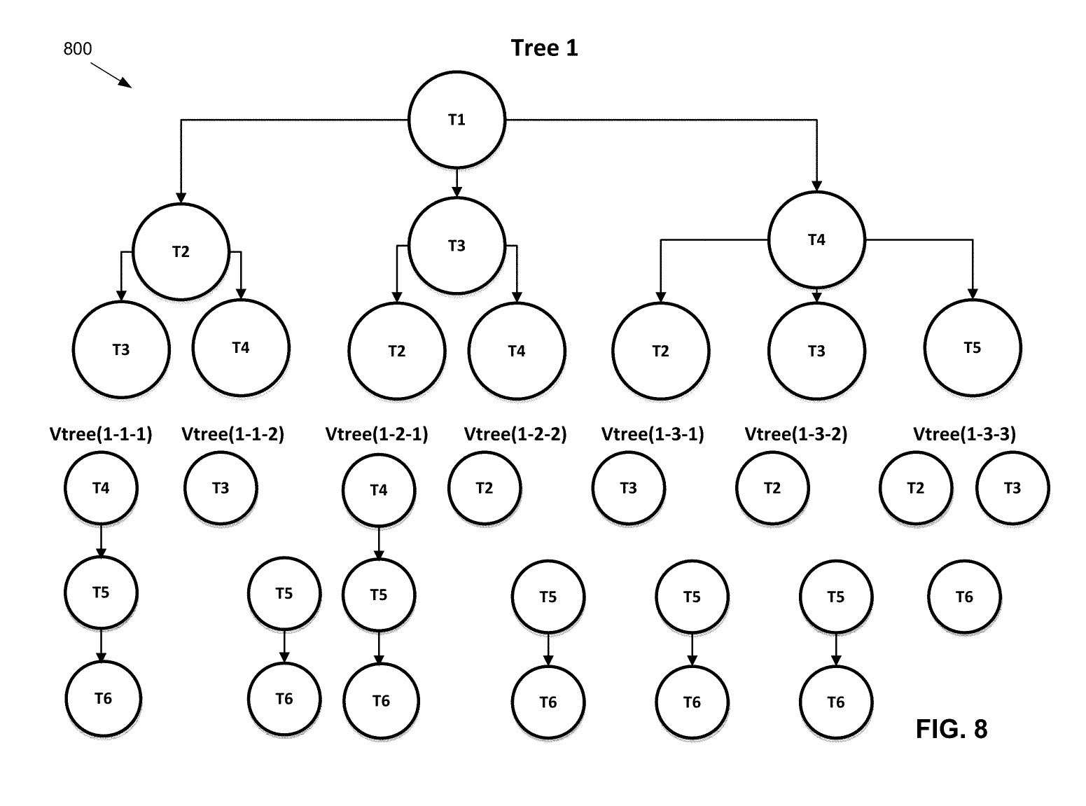

FIG. 8 is an expansion 800 of Tree 1 from the topological diagram in FIG. 7. The steps performed to get the tree in FIG. 7 have been repeated.

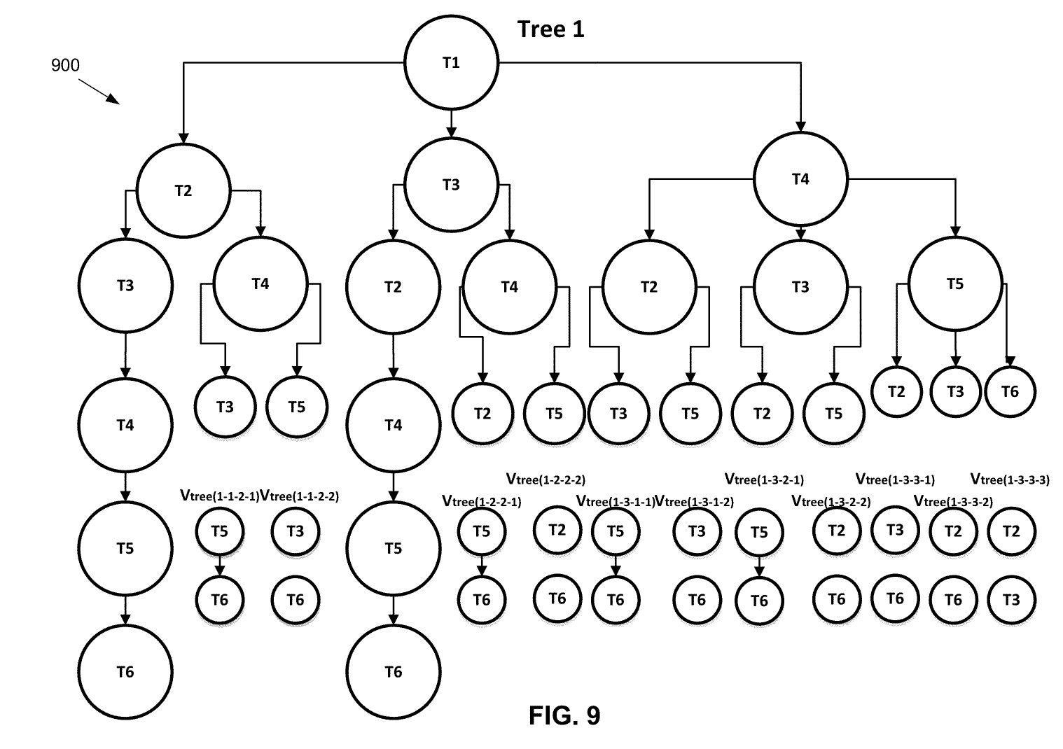

FIG. 9 is an expansion 900 of Tree 1 from the topological diagram in FIG. 8.

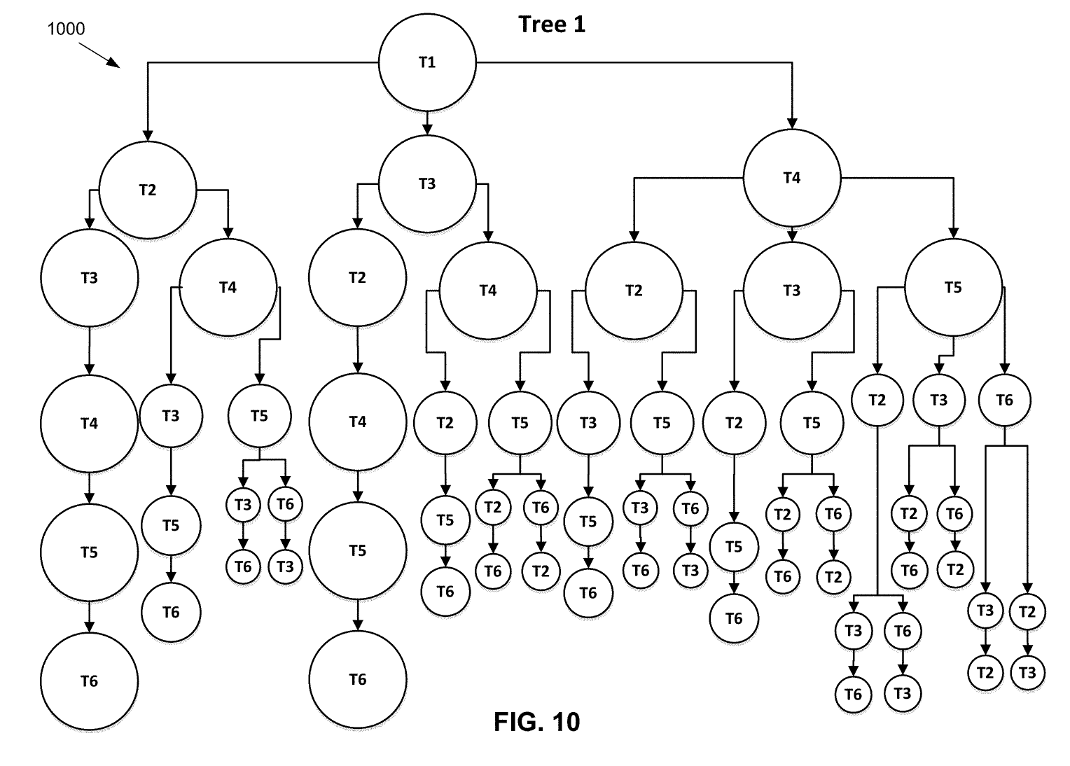

FIG. 10 is an expansion 1000 of Tree 1 from the topological diagram in FIG. 9. The diagram depicts the set of possible task sequences derived from Tree 1.

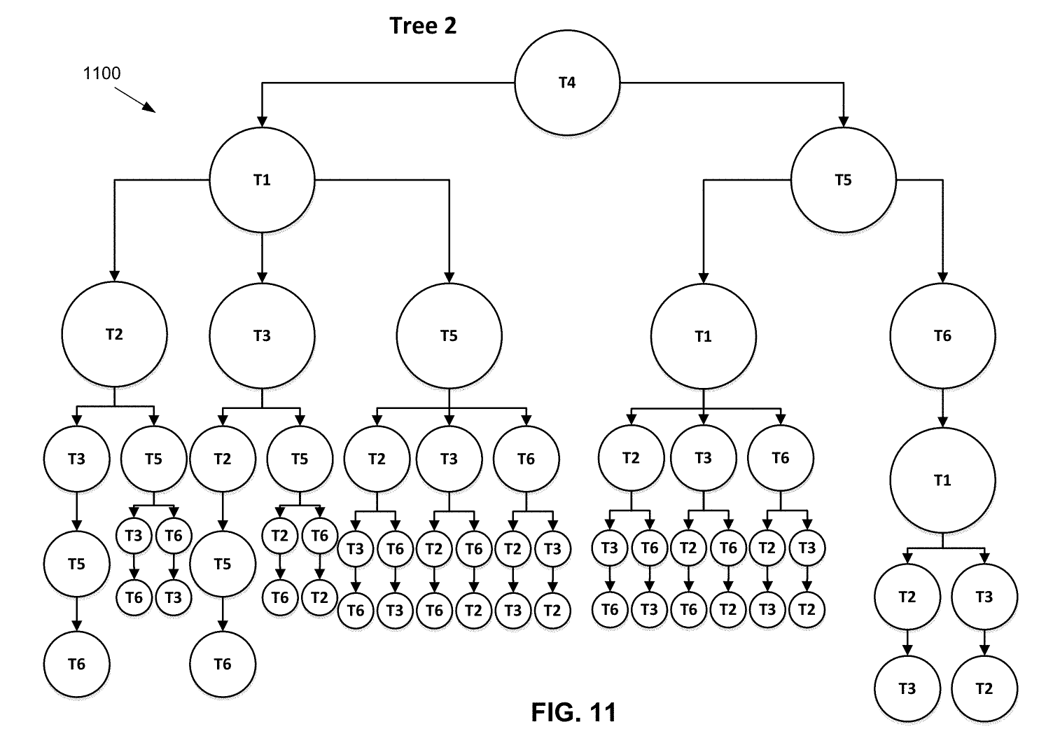

FIG. 11 is a full expansion 1100 of Tree 2 from the topological diagram in FIG. 6.

An exemplary set of possible task sequences derived from Tree 1 are: {T₁, T₂, T₃, T₄, T₅, T₆}, {T₁, T₂, T₄, T₃, T₅, T₆}, {T₁, T₂, T₄, T₅, T₃, T₆}, {T₁, T₂, T₄, T₅, T₆, T₃}, {T₁, T₃, T₂, T₄, T₅, T₆}, {T₁, T₃, T₄, T₂, T₅, T₆}, {T₁, T₃, T₄, T₅, T₂, T₆}, {T₁, T₃, T₄, T₅, T₆, T₂}, {T₁, T₄, T₂, T₃, T₅, T₆}, {T₁, T₄, T₂, T₅, T₃, T₆}, {T₁, T₄, T₂, T₅, T₆, T₃}, {T₁, T₄, T₃, T₂, T₅, T₆}, {T₁, T₄, T₃, T₅, T₂, T₆}, {T₁, T₄, T₃, T₅, T₆, T₂}, {T₁, T₄, T₅, T₂, T₃, T₆}, {T₁, T₄, T₅, T₂, T₆, T₃}, {T₁, T₄, T₅, T₃, T₂, T₆}, {T₁, T₄, T₅, T₃, T₆, T₂}, {T₁, T₄, T₅, T₆, T₃, T₂}, {T₁, T₄, T₅, T₆, T₂, T₃}.

An exemplary set of possible task sequences derived from Tree 2 are: {T₄, T₁, T₂, T₃, T₅, T₆}, {T₄, T₁, T₂, T₅, T₃, T₆}, {T₄, T₁, T₂, T₅, T₆, T₃}, {T₄, T₁, T₃, T₂, T₅, T₆}, {T₄, T₁, T₃, T₅, T₂, T₆}, {T₄, T₁, T₃, T₅, T₆, T₂}, {T₄, T₁, T₅, T₂, T₃, T₆}, {T₄, T₁, T₅, T₂, T₆, T₃}, {T₄, T₁, T₅, T₃, T₂, T₆}, {T₄, T₁, T₅, T₃, T₆, T₂}, {T₄, T₁, T₅, T₆, T₂, T₃}, {T₄, T₁, T₅, T₆, T₃, T₂}, {T₄, T₅, T₁, T₂, T₃, T₆}, {T₄, T₅, T₁, T₂, T₆, T₃}, {T₄, T₅, T₁, T₃, T₂, T₆}, {T₄, T₅, T₁, T₃, T₆, T₂}, {T₄, T₅, T₁, T₆, T₂, T₃}, {T₄, T₅, T₁, T₆, T₃, T₂}, {T₄, T₅, T₆, T₁, T₂, T₃}, {T₄, T₅, T₆, T₁, T₃, T₂}.

For each sequence of the tasks in the set of possible sequences of the tasks, an allocation of parts required by the tasks in that sequence based on an expected arrival queue of parts required by the tasks of that sequence can be generated by the task scheduling module 196. The expected arrival queue can be represented as follows: {Day(P₁₁), Day(P₁₂), . . . Day(P₁ₙ), Day(P₁ₙ₊₁), . . . Day(P₂₁), Day(P₂₂), . . . Day(P₂ₘ), Day(P₂ₘ₊₁), . . . Day(Pᵢₖ) . . . }

Each allocation can be filtered to remove any tasks that have a corresponding part that is not in the arrival queue by the task scheduling module 196. Within a task sequence, parts needed by each task are allocated to that task. If the expected arrival queue contains Pᵢ(Tⱼ)=1, then the part Pᵢₖ which has earliest expected arrival day can be allocated to the current task Tⱼ. If not all of the parts required by the current task Tⱼ have been successfully allocated from the queue, then the task Tⱼ cannot be fulfilled due to a shortage of parts. In this case, the current task Tⱼ and its follow-up tasks in the time-windowed topology structure are removed from the path, and the parts allocated to these tasks are released back to the queue.

Continuing with the previous example, suppose the tasks have the following parts requirements, as indicated by the table below. Task T₁ requires part P₁. Task T₂ requires parts P₂ and P₃. Task T₃ requires parts P₃ and P₄. Task T₄ requires parts P₃ and P₅. Task T₅ requires part P₆. Task T₆ requires part P₇.

| Task | Required Part(s) |
|---|---|
| T₁ | P₁ |
| T₂ | P₂, P₃ |
| T₃ | P₃, P₄ |
| T₄ | P₃, P₅ |
| T₅ | P₆ |
| T₆ | P₇ |

The expected arrival day of part Pᵢₖ is represented by Day(Pᵢₖ). This representation is useful because there might be different delivery dates for different instances of the same part. Within the specified time window, there can be a queue of available parts with expected arrival days. The expected arrival queue can be represented by {Day(P₁₁), Day(P₂₁), Day(P₃₁), Day(P₃₂), Day(P₄₁), Day(P₅ᵢ), Day(P₆₁), Day(P₇₁)}.

To simplify the example, three of the sequences in the set of possible sequences have been chosen. The three chosen sequences are: {T₁, T₂, T₄, T₃, T₅, T₆}, {T₄, T₅, T₁, T₃, T₆, T₂}, and {T₁, T₂, T₃, T₄, T₅, T₆}. An allocation can be generated for each of the sequences. For the final allocation, tasks not capable of completion and subsequent tasks are removed, and the parts allocated to those tasks are released back to the queue.

The allocation for the first sequence can be represented as follows: Allocation ({T₁, T₂, T₄, T₃, T₅, T₆})={<T₁, Day(P₁₁)>, <T₂, Day(P₂₁), Day(P₃₁)>, <T₄, Day (P₃₂), Day (P₅₁)>, <T₅, Day (P₆₁)>, <T₆, Day(P₇₁)>}. Task T₃ cannot be included in the allocation due to the shortage of required part P₃. The two instances of P₃ have been allocated to T₂ and T₄.

The allocation for the second sequence can be represented as follows: Allocation ({T₄, T₅, T₁, T₃, T₆, T₂})={<T₄, Day (P₃₁), Day (P₅₁)>, <T₅, Day (P₆₁)>, <T₁, Day (P₁₁)>, <T₃, Day (P₃₂), Day (P₄₁)>, <T₆, Day (P₇₁)>}. Task T₂ cannot be included in the allocation due to a shortage of required part P₃.

The allocation for the third sequence can be represented as follows: Allocation ({T₁, T₂, T₃, T₄, T₅, T₆})={<T₁, Day (P₁₁)>, <T₂, Day (P₂₁), Day (P₃₁)>, <T₃, Day (P₃₂), Day (P₄₁)>}. Task T₄ cannot be included in the allocation due to a shortage of required part P₃. Since Task T₄ cannot be executed, the subsequent tasks T₅ and T₆ cannot be executed as well.

A sequence of the tasks in the set of possible sequences of the tasks can be selected based on the value for the workload metric for the sequence by the task scheduling module 196. A workload metric provides the basis for ranking the allocations. The definition of workload can be flexible and should be decided according to the business needs. For example, the workload can be defined as: (i) a number of tasks that are capable of completion, (ii) a total of working hours of the tasks that are capable of completion, or (iii) a cost of completing the tasks that are capable of completion. If the user does not choose a workload metric, the system can use a default workload metric. After determining the allocations, the system generates a value for at least one workload metric for each allocation. Then the system selects a sequence of tasks based on the workload metric value. To simplify the example, a workload metric of a number of tasks that are capable of completion can be chosen. Allocation ({T₁, T₂, T₄, T₃, T₅, T₆}) and Allocation ({T₄, T₅, T₁, T₃, T₂, T₆}) will have equivalent value of six (6) for the workload metric. Thus, these two allocations will both be rolled into the next phase. Allocation ({T₁, T₂, T₃, T₄, T₅, T₆}) will be discarded because its workload metric value is three (3).

At this point, a set of allocations have been selected based on the workload metric value. The next step is to choose the best allocation from the set through “probability based topological sorting.”

A probability of availability of each part required by the tasks of the sequence can be generated by the task scheduling module 196 and based on at least one of: (i) historical delivery data for that part and (ii) historical damage data for that part. Even if the tasks were scheduled based on the arrival time of the parts, the resulting schedule would potentially become obsolete as soon as the supply chain data was updated. As one example, the parts might be unavailable at the time planned due to damage to the parts during the transportation as indicated by IoT sensors. As another example, the delivery could be delayed due to inclement weather or the late sending of parts. Historical damage and delay data might also indicate that the probability of parts availability is low.

The calculation of the probability of part availability is based on damage and delay data derived from the IoT sensor data and the historical inspection record of the parts. Even if Pᵢ is sent on time, the part can also be damaged by environmental conditions, such as low temperature or heavy shock, in transit.

Digital outputs based on IoT sensor data associated with a part or parts can be received by the one or more servers 160 or the IoT gateway 120, in conjunction with the IoT sensors 110, 111, and 112. The digital outputs can represent physical properties of the part(s), where the part(s) have expected delivery dates. The physical properties associated with the part(s) are independently selected from the group consisting of humidity, temperature, and shock.

The temperature of part Pᵢ in transit can be represented by temp, the shock level of part Pᵢ in transit can be represented by shock, and the humidity of part Pᵢ in transit can be represented by humid. In one example, the temperature and humidity can be read directly from the IoT platform. In one example, the shock level can be calculated using the angular velocity of the x, y, and z axes, denoted by ωₓ, ω_{y}, ω_{z}. The relationship between shock and angular velocity can be shown in the table below.

| ωₓ (rad/s) | ω_{y} (rad/s) | ω_{z} (rad/s) | Shock level |
|---|---|---|---|
| 0 ≤ ωₓ < 1 | 0 ≤ ω_{y} < 1 | 0 ≤ ω_{z} < 1 | 1 |
| 1 ≤ ωₓ < 2 | 1 ≤ ω_{y} < 2 | 1 ≤ ω_{z} < 2 | 2 |
| 2 ≤ ωₓ < 3 | 2 ≤ ω_{y} < 3 | 2 ≤ ω_{z} < 3 | 3 |
| 3 ≤ ωₓ < 4 | 3 ≤ ω_{y} < 4 | 3 ≤ ω_{z} < 4 | 4 |
| 4 ≤ ωₓ < 5 | 4 ≤ ω_{y} < 5 | 4 ≤ ω_{z} < 5 | 5 |
| 5 ≤ ωₓ < 6 | 5 ≤ ω_{y} < 6 | 5 ≤ ω_{z} < 6 | 6 |
| 6 ≤ ωₓ < 7 | 6 ≤ ω_{y} < 7 | 6 ≤ ω_{z} < 7 | 7 |
| 7 ≤ ωₓ < 8 | 7 ≤ ω_{y} < 8 | 7 ≤ ω_{z} < 8 | 8 |
| 8 ≤ ωₓ < 9 | 8 ≤ ω_{y} < 9 | 8 ≤ ω_{z} < 9 | 9 |
| ωₓ ≥ 9 | ω_{y} ≥ 9 | ω_{z} ≥ 9 | 10 |

The shock threshold can be represented by T_{shock}. If shock>T_{shock}, the part Pᵢ will likely be damaged. The threshold of the highest temperature can be represented by THₜₑₘₚ and the threshold of the lowest temperature can be represented by TLₜₑₘₚ. If temp<TLₜₑₘₚ or temp>THₜₑₘₚ, the part Pᵢ will likely be damaged. The threshold of the highest humidity can be represented by TH_{humid}, and the threshold of the highest humidity and TLₜₑₘₚ to represent the threshold of the lowest humidity. If humid<TL_{humid} or humid>TH_{humid}, the part Pᵢ will likely be damaged.

The probability of arrival of part Pᵢₖ on a particular day, Day(Pᵢₖ), can be calculated by the task scheduling module 196 and represented as Prob(Day(Pᵢₖ). The probability of the day of arrival indicates that the planned date of availability may not be correct due to delay or damage. Here, day_{orde}_{_}₁ represents the day that Pᵢ was ordered from the supplier, dayₛₑₙₜ_{_}ᵢ represents the day Pᵢ should be sent from the supplier, and dayₐᵣᵣᵢ_{_}ᵢ represents the day part Pᵢ should arrive. If part Pᵢ is sent the same day as the day the part was ordered, then day_{orde}_{_}ᵢ=dayₛₑₙₜ_{_}ᵢ. The number of days required for the transportation of part Pᵢ from the supplier can be represented by Nᵢ in the formula below:

Nᵢ=dayₐᵣᵣᵢ_{_}ᵢ−day_{orde}_{_}ᵢ

If day_{orde}_{_}ᵢ<dayₛₑₙₜ_{_}ᵢ, the part Pᵢ will be delayed, and the task that requires Pᵢ will need to be rescheduled.

In a prior time window, the total number of orders of Pᵢ can be counted, the total number of delayed delivery times of Pᵢ by the supplier, and the total number of damaged times of Pᵢ in transit. Prob(Day(Pᵢₖ)) can be represented by the formula below:

$$Prob ( Day ( {P}_{ik} ) ) = Prob ( Day ( {P}_{i} ) ) = 1 - \frac{{N}_{de} {N}_{da}}{{N}_{t}}$$

In the formula above, N_{de} represents the total number of delayed delivery times of Pᵢ, N_{da} represents the total number of damaged times of Pᵢ, Nₜ represents the number of total orders of Pᵢ.

A task score can be generated by the task scheduling module 196 for each task in the first sequence that requires a part based on the probability of availability of that part. Each allocation with a favorable workload value can be scored based on probability. Within each allocation, each task Tᵢ can be scored. The score of a certain task consists of three individual scores: the score of task start, the score of task execution, and the score of unable to start. The final task score is the sum of the three scores. The total score for the allocation is a sum of task scores of all of the tasks in the allocation. The allocation with the minimum score is the recommended allocation.

If task Ti has no previous tasks, the calculation of three task scores is straightforward. The starting day of Tᵢ is represented by DAY_BEGIN(Tᵢ) and the ending day of Tᵢ is represented by DAY_END(Tᵢ). The starting day of task Tᵢ, the latest day among the expected available days of all the parts allocated to the task, can be represented as follows:

DAY_BEGIN(T₁)=MAX{Day(P₁₁),Day(P₁₂), . . . Day(Pᵢₖ)}.

The ending day of task Tᵢ is the starting day of the task plus the duration of task Tᵢ, D_{Ti}, represented as follows:

DAY_END(Tᵢ)=DAY_BEGIN(Tᵢ)+D_{Ti}.

The probability of starting task Tᵢ, Prob (Tᵢ), can be expressed as a product of on the probabilities of arrival of the parts needed by the task:

Prob(Tᵢ)=Prob(Day(P₁₁))*Prob(Day(P₁₂))* . . . *Prob(Day(Pᵢₖ))

The maximum leading days before task Tᵢ could be started, EM_LEADING_DAY_START(Tᵢ), which provides the basis for the first score, and can be based on the probability of starting task Tᵢ, Prob(Tᵢ) and the starting day of task Tᵢ, DAY_BEGIN(Tᵢ):

EM_LEADING_DAY_START(Tᵢ)=Prob(Tᵢ)*DAY_BEGIN(Tᵢ)

The days needed for executing task Tᵢ is represented by DAY_EXECUTION(Tᵢ), which provides the basis for the second score, and can be based on the probability of starting task Tᵢ, Prob(Tᵢ), and the duration of the task Tᵢ, D_{Ti}:

DAY_EXECUTION(Tᵢ)=Prob(Tᵢ)*D_{Ti}

The minimum leading days before Tᵢ for which there is certainty that the task cannot be started, represented by EM_LEADING_DAY_NOT_START(Tᵢ), provides the basis for the third score. The number of minimum leading days can be based on the probability of starting task Tᵢ, Prob(Tᵢ), and the probabilities of arrival of the parts needed by the task:

EM_LEADING_DAY_NOT_START(Tᵢ)=(1−Prob(Tᵢ))*MIN{(1−Prob(Day(P₁₁)))*Day(P₁₁),(1−Prob(Day(P₁₂)))*Day(P₁₂), . . . (1−Prob(Day(Pᵢₖ)))*Day(Pᵢₖ)}

The final task score of task Tᵢ, based on the unit cost of Tᵢ, UC_{Ti}, can be represented as:

EM_LEADING_DAY_START(Tᵢ)*UC_{Ti}+DAY_EXECUTION(Tᵢ)*UC_{Ti}+EM_LEADING_DAY_NOT_START(Tᵢ)*UC_{Ti}

If Task T₁ has previous tasks, the calculation of the task score takes the previous tasks into account. The task score can be impacted by the previous tasks. The previous tasks of task Tᵢ can be represented as follows:

̂Tᵢ={T₁,T₂ . . . ,Tₖ}.

The starting day of Tᵢ can be represented by DAY_BEGIN(Tᵢ) and the ending day of Tᵢ can be represented by DAY_END(Tᵢ). The starting day of task Tᵢ, the latest day among the expected available days of all the parts allocated to the task and the end day of all of its previous task, can be represented as follows:

DAY_BEGIN(Tᵢ)=MAX{Day(P₁₁),Day(P₁₂), . . . Day(Pᵢₖ),DAY_END(̂Tᵢ)},

The ending day of task Tᵢ, the starting day of the task plus the duration of task Tᵢ, D_{Ti}, can be represented as follows:

DAY_END(Tᵢ)=DAY_BEGIN(Tᵢ)+D_{Ti}.

The probability of starting all previous tasks of task Tᵢ, represented by Prob(̂Tᵢ), depends on the probabilities of starting each previous task of Tᵢ:

Prob(̂Tᵢ)=Prob(T₁)*Prob(T₂)* . . . *Prob(Tₖ)

As an example, if Tₐ and T_{b} are the previous tasks of T_{c}, then Prob(̂T_{c})=Prob(Tₐ)*Prob(T_{b}).

The probability of starting task Tᵢ can be represented by Prob (Tᵢ), and it can be based on the probabilities of arrival of the parts needed by the task as well as the probability of starting all previous tasks of task Tᵢ:

Prob(Tᵢ)=Prob(̂Tᵢ)*Prob(Day(P₁₁))*Prob(Day(P₁₂))* . . . *Prob(Day(Pᵢₖ))

The maximum leading days before task Tᵢ could be started can be represented by EM_LEADING_DAY_START(Tᵢ), which provides the basis for the first score. The number of maximum leading days can be based on the probability of starting task Tᵢ, Prob(Tᵢ) and the starting day of task Tᵢ, DAY_BEGIN(Tᵢ):

EM_LEADING_DAY_START(Tᵢ)=Prob(Tᵢ)*DAY_BEGIN(Tᵢ)

The days needed for executing task Tᵢ can be represented by DAY_EXECUTION(Tᵢ), which can provide the basis for the second score. The number of days needed for executing the task can be based on the probability of starting task Tᵢ, Prob(Tᵢ), and the duration of the task Tᵢ, D_{Ti}:

DAY_EXECUTION(Tᵢ)=Prob(Tᵢ)*D_{Ti}

The minimum leading days before Tᵢ for which there is certainty that the task cannot be started, represented by EM_LEADING_DAY_NOT_START(Tᵢ), provides the basis for the third score:

EM_LEADING_DAY_NOT_START(Tᵢ)=MIN{EM_LEADING_DAY_NOT_START(T₁),EM_LEADING_DAY_NOT_START(T₂), . . . ,EM_LEADING_DAY_NOT_START(Tₖ)}+(1−Prob(Day(P₁₁))*Prob(Day(P₁₂))* . . . *Prob(Day(Pᵢₖ)))*MIN{(1−Prob(Day(P₁₁)*Day(P₁₁),(1−Prob(Day(P₁₂)))*Day(P₁₂), . . . (1−Prob(Day(Pᵢₖ)))*Day(Pᵢₖ)}

The minimum leading days before the previous tasks of task Tᵢ for which there is certainty that the previous tasks cannot be started, can be represented in the preceding equation by the expression: MIN{EM_LEADING_DAY_NOT_START(T₁), EM_LEADING_DAY_NOT_START(T₂), . . . , EM_LEADING_DAY_NOT_START(Tₖ)}. The probabilities of arrival of the parts needed by the previous tasks is represented in the preceding equation by the expression: (1−Prob(Day(P₁₁))*Prob(Day(P₁₂))* . . . *Prob(Day(Pᵢₖ)))*MIN{(1-Prob(Day(P₁₁)))*Day(P₁₁), (1−Prob(Day(P₁₂)))*Day(P₁₂), . . . (1−Prob(Day(Pᵢₖ)))*Day(Pᵢₖ)}.

The final task score of task Tᵢ that has previous tasks can be based on the unit cost of a task Tᵢ, UC_{Ti}. The final task score can be represented as:

EM_LEADING_DAY_START(Tᵢ)*UC_{Ti}+DAY_EXECUTION(Tᵢ)*UC_{Ti}+EM_LEADING_DAY_NOT_START(Tᵢ)*UC_{Ti}

The calculations above reflect the fact that the lower the probability of availability of a part, the lower the score of task start and score of task execution, and the higher the score of unable to start. In other words, if the probability of availability of a part is low, the task that needs the part will be less likely to start on-time. Furthermore, the task that needs the part will be more likely to not meet the expected execution time. Lastly, the minimum number of leading days before Tᵢ for which there is certainty that the task cannot be started will likely increase.

A total score for the sequence of tasks based on the task scores of the tasks in the sequence is generated by the task scheduling module 196. The total score of a certain allocation can be based on the sum of the individual task scores for all of the tasks in the allocation:

Score(Allocation)=Σ(Score(Tᵢ))

A recommended scheduling of tasks based on the total score can be generated by the task scheduling module 196. After scoring the allocations, the system recommends the allocation with the minimum total score. This recommended allocation will become the task scheduling for the manufacturing production line.

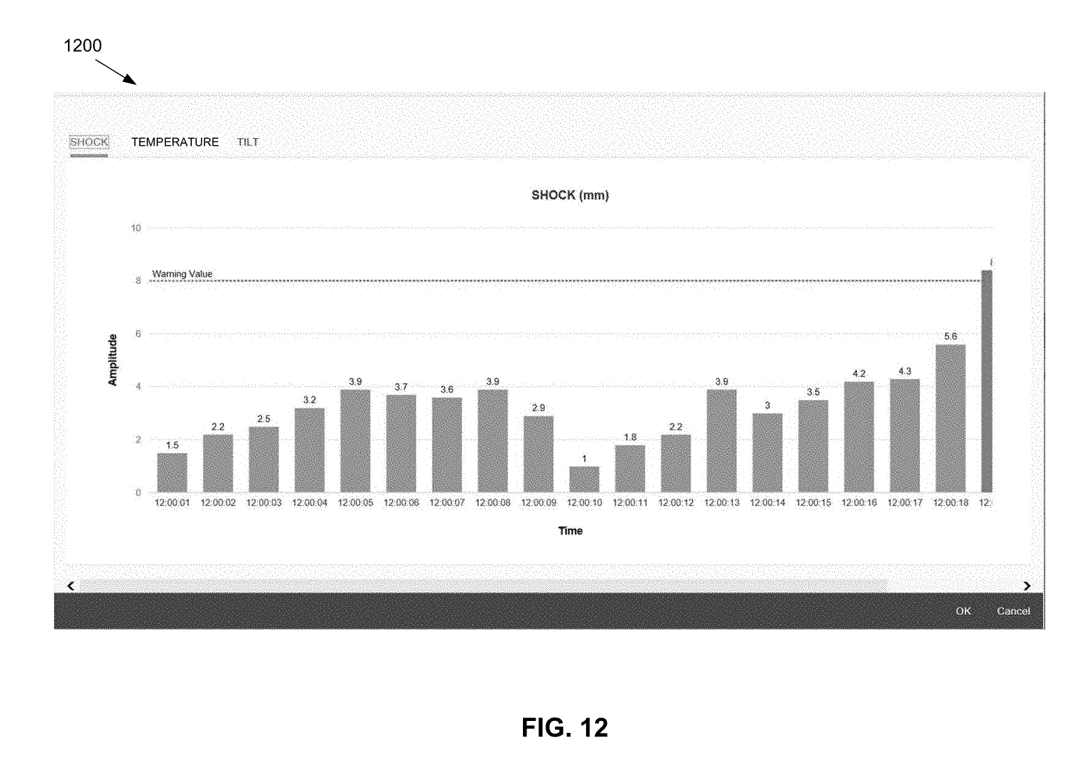

FIG. 12 depicts an exemplary user interface 1200 that displays values for shock. Digital outputs that indicate the shock of the parts is displayed at 1200.

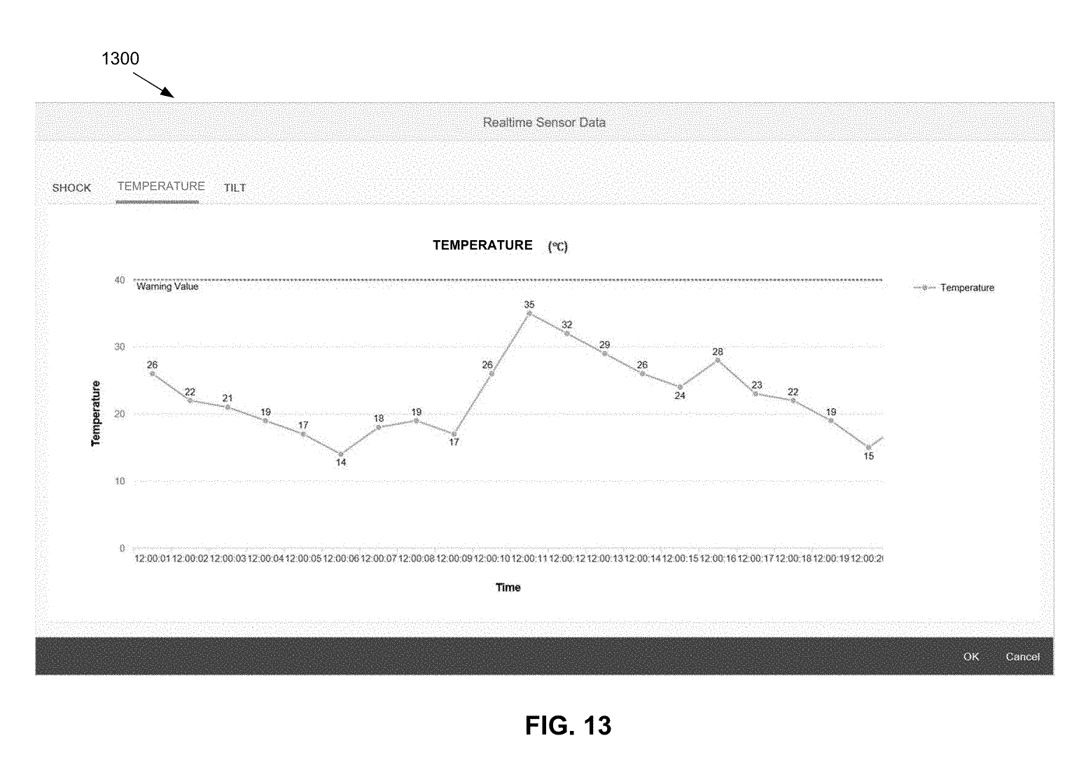

FIG. 13 depicts an exemplary user interface 1300 that displays values for temperature. Digital outputs that indicate the temperature of the parts is shown at 1300.

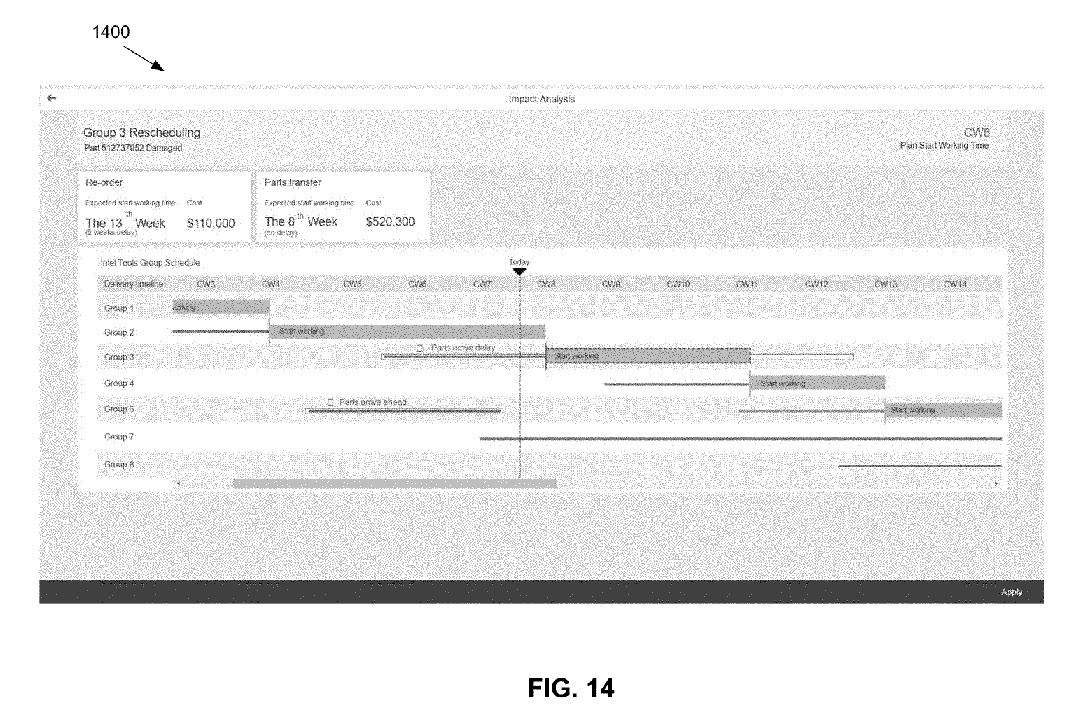

FIG. 14 depicts an exemplary user interface 1400 that displays a recommended task schedule. A recommended scheduling of tasks is output by the task scheduling module 196 to at least one of a display screen and a computer-readable medium. A Gantt chart depicting the various allocations is shown in 1400. Also at 1400, the recommended task allocation is highlighted.

### Additional Examples

An overview of exemplary operations in a non-limiting configuration of a process flow is provided below. Additional details regarding certain operations also are provided.

One or more aspects or features of the subject matter described herein can be realized in digital electronic circuitry, integrated circuitry, specially designed application specific integrated circuits (ASICs), field programmable gate arrays (FPGAs), computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, can include machine instructions for a programmable processor, and/or can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, solid-state storage devices, memory, and Programmable Logic Devices (PLDs), used to provide machine instructions and/or data to a programmable data processor, including a machine-readable medium that receives machine instructions as a computer-readable signal. The term “computer-readable signal” refers to any signal used to provide machine instructions and/or data to a programmable data processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, such as for example as would a processor cache or other random access memory associated with one or more physical processor cores.

The computer components, software modules, functions, data stores and data structures described herein can be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality can be located on a single computer or distributed across multiple computers depending upon the situation at hand.

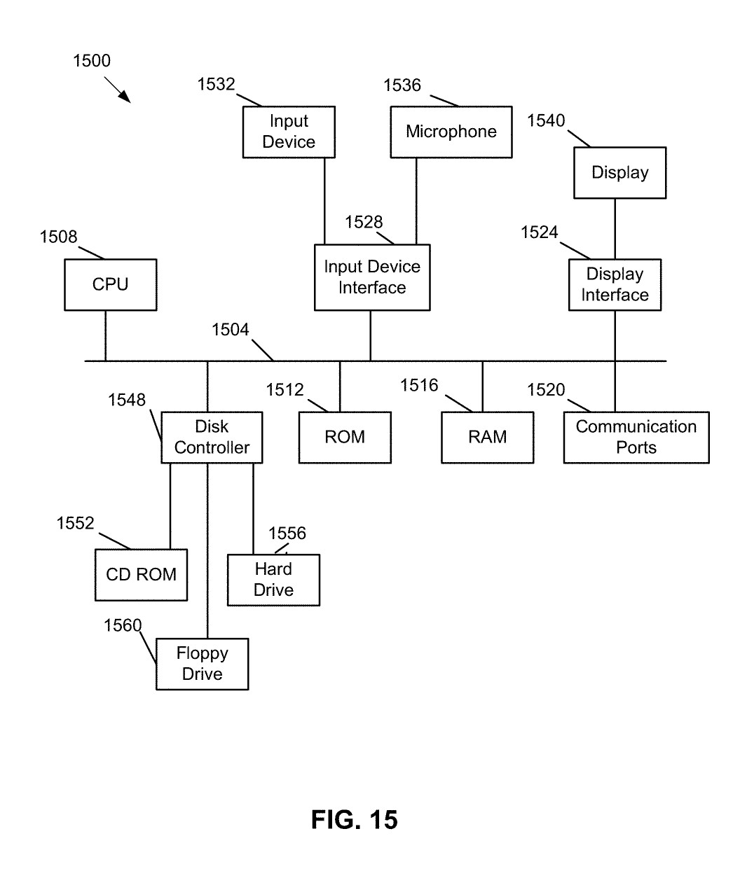

FIG. 15 is a diagram 1500 illustrating a sample computing device architecture for implementing various aspects described herein, such as any aspect that can be processed using server(s) 160 or processing system 190 executing logistics process modeling module 192, core engine 194, or task scheduling module 196. A bus 1504 can serve as the information highway interconnecting the other illustrated components of the hardware. A processing system 1508 labeled CPU (central processing unit) (e.g., one or more computer processors/data processors at a given computer or at multiple computers), can perform calculations and logic operations required to execute a program. A non-transitory processor-readable storage medium, such as read only memory (ROM) 1512 and random access memory (RAM or buffer) 1516, can be in communication with the processing system 1508 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 1548 can interface one or more optional disk drives to the system bus 1504. These disk drives can be external or internal floppy disk drives such as 1560, external or internal CD-ROM, CD-R, CD-RW or DVD, or solid state drives such as 1552, or external or internal hard drives 1556. As indicated previously, these various disk drives 1552, 1556, 1560 and disk controllers are optional devices. The system bus 1504 can also include at least one communication port 1520 to allow for communication with external devices either physically connected to the computing system or available externally through a wired or wireless network. In some cases, the communication port 1520 includes or otherwise comprises a network interface.

To provide for interaction with a user, the subject matter described herein can be implemented on a computing device having a display device 1540 (e.g., a CRT (cathode ray tube) or LCD (liquid crystal display) monitor) for displaying information obtained from the bus 1504 to the user and an input device 1532 such as keyboard and/or a pointing device (e.g., a mouse or a trackball) and/or a touchscreen by which the user can provide input to the computer. Other kinds of input devices 1532 can be used to provide for interaction with a user as well; for example, feedback provided to the user can be any form of sensory feedback (e.g., visual feedback, auditory feedback by way of a microphone 1536, or tactile feedback); and input from the user can be received in any form, including acoustic, speech, or tactile input. In the input device 1532 and the microphone 1536 can be coupled to and convey information via the bus 1504 by way of an input device interface 1528. Other computing devices, such as dedicated servers, can omit one or more of the display 1540 and display interface 1324, the input device 1532, the microphone 1536, and input device interface 1528.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented tracking method, the method comprising:
receiving, by one or more data processors, a first digital output based on first Internet of Things (IoT) sensor data associated with a first part, the first digital output representing a first physical property of the first part, the first part having a first expected delivery date;
receiving, by one or more data processors, a second digital output based on second IoT sensor data associated with a second part, the second digital output representing a second physical property of the second part, the second part having a second expected delivery date;
wherein the first and second physical properties are independently selected from the group consisting of humidity, temperature, and shock;
comparing, by one or more data processors, the first digital output to a first predetermined value representing damage to the first part;
comparing, by one or more data processors, the second digital output to a second predetermined value representing damage to the second part;
determining, by one or more data processors, that the first part is damaged and will not be available on the first expected delivery date based on the comparison of the first digital output to the first predetermined value;
determining, by one or more data processors, that the second part is not damaged and will be available on the second expected delivery date based on the comparison of the second digital output to the second predetermined value;
generating, by one or more data processors, an alert that the first part will not arrive on the first expected delivery date based on the determination that the first part is damaged; and
outputting, by one or more data processors, the alert to at least one of a display screen and a computer-readable medium.

2. The method of claim 1, further comprising, receiving, by one or more data processors, a third digital output based on third IoT sensor data from a third IoT sensor associated with the first part, the third digital output representing a location of the first part.

3. The method of claim 1, wherein the determining that the first part will not be available on the first expected delivery date is based on a comparison of the first digital output to a range of predetermined values.

4. The method of claim 2, wherein the determining that the first part will not be available on the first expected delivery date is based upon the location of the part, wherein the location of the first part indicates that a delivery of the first part is delayed.

5. The method of claim 1, wherein the first part and the second part have different locations of origin.

6. A system for tracking, the system comprising:
a first Internet of Things (IoT) sensor associated with a first part and configured to generate first IoT sensor data representing a first physical property of the first part, the first part having a first expected delivery date;
a second IoT sensor associated with a second part and configured to generate second IoT sensor data representing a second physical property of the second part, the second part having a second expected delivery date;
wherein the first and second physical properties are independently selected from the group consisting of humidity, temperature, and shock; and
at least one data processor having memory storing instructions, which when executed, result in operations comprising:
comparing a first digital output based on first IoT sensor data to a first predetermined value representing damage to the first part;
comparing a second digital output based on second IoT sensor data to a second predetermined value representing damage to the second part;
determining that the first part is damaged and will not be available on the first expected delivery date based on the comparison of the first digital output to the first predetermined value;
determining that the second part is not damaged and will be available on the second expected delivery date based on the comparison of the second digital output to the second predetermined value;
generating an alert that the first part will not arrive on the first expected delivery date based on the determination that the first part is damaged; and
outputting the alert to at least one of a display screen and a computer-readable medium.

7. The system of claim 6, further comprising, a third IoT sensor associated with the first part, and configured to generate third IoT sensor data representing a location of the first part.

8. The system of claim 6, wherein the determining that the first part will not be available on a first expected delivery day is based on a comparison of the first digital output to a range of predetermined values.

9. The system of claim 7, wherein the determining that the first part will not be available on a first expected delivery day is based upon a location of the part, wherein the location of the part indicates that a delivery of the first part is delayed.

10. The system of claim 6, wherein the first part and the second part have different locations of origin.

11. A computer-implemented method comprising:
generating, by one or more data processors, a set of possible sequences of tasks in manufacturing a product, at least some of the tasks requiring a corresponding part, and at least some of the tasks having relationships with one another;
for each sequence of the tasks in the set of possible sequences of the tasks:
generating, by one or more data processors, an allocation of parts required by the tasks in that sequence based on an expected arrival queue of parts required by the tasks of that sequence;
filtering, by one or more data processors, the allocation to remove any tasks that have a corresponding part that is not in the arrival queue; and
generating, by one or more data processors, a value for a workload metric based on the filtered allocation;
selecting, by one or more data processors, a sequence of the tasks in the set of possible sequences of the tasks based on the value for the sequence;
generating, by one or more data processors, a probability of availability of each part required by the tasks of the sequence based on at least one of: (i) historical delivery data for that part and (ii) historical damage data for that part;
generating, by one or more data processors, a task score for each task in the first sequence that requires a part based on the probability of availability of that part;
generating, by one or more data processors, a total score for the sequence of tasks based on the task scores of the tasks in the sequence;
generating, by one or more data processors, a recommended scheduling of tasks based on the total score; and
outputting, by one or more data processors, the recommended scheduling of tasks to at least one of a display screen and a computer-readable medium.

12. The method of claim 11, wherein the relationships of the tasks are based on a predefined time window.

13. The method of claim 11, wherein the workload metric comprises at least one of: (i) a number of tasks that are capable of completion, (ii) a total of working hours of the tasks that are capable of completion, and (iii) a cost of completing the tasks that are capable of completion.

14. The method of claim 11, wherein the historical delivery data for that part comprises a number of times that that part has been delayed.

15. The method of claim 11, wherein the historical damage data for that part is based on measurements of at least one physical property of that part, wherein the at least one physical property comprises temperature, humidity, or shock.

16. The method of claim 11, wherein the task score for each task is based on a set of probabilities of previous tasks, each probability in the set of probabilities comprising the probability of availability for each part needed by each previous task.

17. A system, comprising:
at least one database that stores data comprising relationships between tasks and at least one of (i) historical delivery data for parts and (ii) historical damage data for parts, wherein the parts are needed by the tasks; and
at least one data processor having memory storing instructions, which when executed result in operations comprising:
generating a set of possible sequences of tasks in manufacturing a product, at least some of the tasks requiring a corresponding part, and at least some of the tasks having relationships with one another;
for each sequence of the tasks in the set of possible sequences of the tasks:
generating an allocation of parts required by the tasks in that sequence based on an expected arrival queue of parts required by the tasks of that sequence;
filtering the allocation to remove any tasks that have a corresponding part that is not in the arrival queue; and
generating a value for a workload metric based on the filtered allocation;
selecting, by one or more data processors, a sequence of the tasks in the set of possible sequences of the tasks based on the value for the sequence;
generating probability of availability of each part required by the tasks of the sequence based on at least one of: (i) historical delivery data for that part and (ii) historical damage data for that part;
generating a task score for each task in the first sequence that requires a part based on the probability of availability of that part;
generating a total score for the sequence of tasks based on the task scores of the tasks in the sequence;
generating a recommended scheduling of tasks based on the total score; and
outputting the recommended scheduling of tasks to at least one of a display screen and a computer-readable medium.

20. A non-transitory computer readable storage medium storing one or more programs configured to be executed by one or more data processors, the one or more programs comprising instructions, the instructions comprising:
generating a set of possible sequences of tasks in manufacturing a product, at least some of the tasks requiring a corresponding part, and at least some of the tasks having relationships with one another;
for each sequence of the tasks in the set of possible sequences of the tasks:
generating an allocation of parts required by the tasks in that sequence based on an expected arrival queue of parts required by the tasks of that sequence;
filtering the allocation to remove any tasks that have a corresponding part that is not in the arrival queue; and
generating a value for a workload metric based on the filtered allocation;
selecting a sequence of the tasks in the set of possible sequences of the tasks based on the value for the sequence;
generating a probability of availability of each part required by the tasks of the sequence based on at least one of: (i) historical delivery data for that part and (ii) historical damage data for that part;
generating a task score for each task in the first sequence that requires a part based on the probability of availability of that part;
generating a total score for the sequence of tasks based on the task scores of the tasks in the sequence;
generating a recommended scheduling of tasks based on the total score; and
outputting the recommended scheduling of tasks to at least one of a display screen and a computer-readable medium.
